(19) United States
(12) Patent Application Publication
(10) Pub. No.: US 2005/0058866 A1
(43) Pub. Date: Mar. 17, 2005

(54) Integrated platform and fuel cell cooling

(75) Inventors: Michael J. Rocke, Pleasanton, CA (US); Himanshu Pokharna, San Jose, CA (US); Eric DiStefano, Livermore, CA (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/662,503

(22) Filed: Sep. 15, 2003

(51) Int. Cl. H01M 8/04

(52) U.S. Cl. 429/26; 429/24; 429/13

(57) ABSTRACT

A first cooling system pre-heats a fuel for a fuel cell, and a second cooling system cools a heat generating device using a fluid medium.

### FIELD

The present invention relates generally to cooling electronic systems, and more specifically to cooling of systems that include fuel cells.

### BACKGROUND

Fuel cells typically generate heat as a by-product of operation. As fuel cell designs mature and fuel cells become smaller, it becomes more difficult to remove the generated heat.

### BRIEF DESCRIPTION OF THE DRAWINGS

FIGS. 1 and 2 show diagrams of electronic systems with two cooling systems;

FIG. 3 shows an exploded view of a fuel cell;

FIG. 4 shows a diagram of a control system;

FIG. 5 shows an electronic system having a processor and memory;

FIG. 6 shows a flowchart in accordance with various embodiments of the present invention; and

FIGS. 7-9 show system diagrams in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

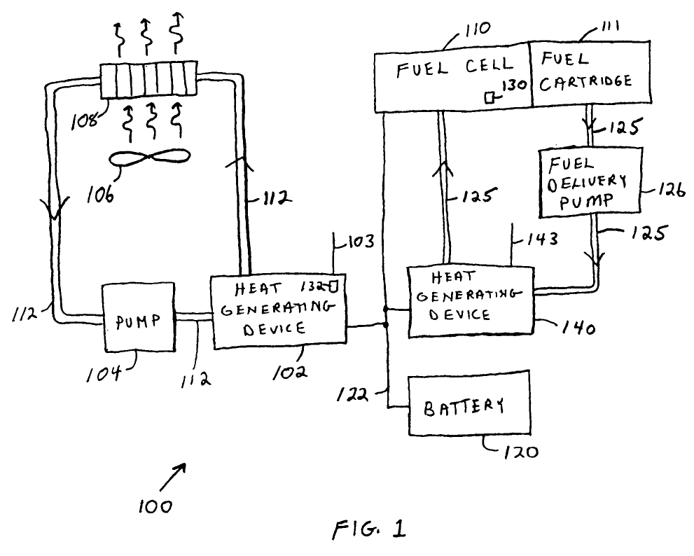

FIG. 1 shows a diagram of an electronic system with two cooling systems. Electronic system 100 includes fuel cell 110, fuel cartridge 111, fuel delivery pump 126, battery 120, and heat generating device 140. Fuel cell 110 may be any type of fuel cell capable of producing power. For example, fuel cell 110 may be a direct methanol fuel cell, a reformed methanol fuel cell, or the like. Fuel cartridge 111 may include fuel for fuel cell 110. For example, fuel cartridge 111 may hold a fuel such as methanol. Battery 120 may be any type of battery capable of storing an electrical charge.

Electronic system 100 includes a first cooling system to cool heat generating device 140 and to pre-heat fuel for fuel cell 110. For example, the first cooling system includes fluid path 125 which starts at fuel cartridge 111 and traverses fuel delivery pump 126 and heat generating device 140 before delivering fuel to fuel cell 110. Path 125 may include flexible tubing, rigid piping, or the like. Fuel delivery pump 126 pumps the fuel from fuel cartridge 111 through fluid path 125. The fuel traverses heat generating device 140, cooling heat generating device 140 while pre-heating the fuel for fuel cell 110.

In some embodiments, heat generating device 140 includes a heat sink having cooling passages through which the fuel can pass. In other embodiments, heat generating device 140 includes packaging having integrated cooling passages through which the fuel can pass.

Electronic system 100 also includes a second cooling system. The second cooling system may be any type of cooling system capable of cooling a heat generating device. For example, in some embodiments, the second cooling system includes cooling system pump 104, fan 106, and heat exchanger 108. The second cooling system may also includes a fluid cooling medium that flows in path 112. Path 112 may include flexible tubing, rigid piping, a heat pipe, or the like. In some embodiments, path 112 may also include valves and quick-disconnects throughout. Path 112 traverses heat generating device 102 to remove heat, and also traverses heat exchanger 108 to remove heat from electronic system 100.

Heat generating devices 102 and 140 may be any devices within electronic system 100 that generate heat. In some embodiments, either of heat generating devices 102 or 140 may include an integrated circuit. For example, heat generating device 140 may include a graphics chip, a processor, a memory device, a memory controller, or the like. Further, either heat generating device 102 or heat generating device 140 may include any number of devices, components, or subsystems in any combination. Paths 112 and 125 may traverse the components or subsystems in any order without departing from the scope of the present invention. Further, in some embodiments, each of heat generating devices 102 and 140 may only include one device.

As shown in FIG. 1, path 112 traverses in the order of heat generating device 102, heat exchanger 108, and pump 104, but this is not a limitation of the present invention. For example, path 112 may traverse heat generating device 102 either before or after heat exchanger 108. Further, in some embodiments, multiple heat exchangers are included. For example, path 112 may traverse one or more heat exchangers after passing through each heat generating device.

In some embodiments, the second cooling system recirculates a fluid cooling medium to cool various components of electronic system 100. The fluid cooling medium may be any type of fluid capable of carrying heat. In some embodiments, the fluid cooling medium may be water, and in other embodiments, the fluid cooling medium may be a liquid metal such as a gallium-indium based low melting point alloy. In some embodiments, the fluid cooling medium experiences a phase change while traversing path 112, and in other embodiments, the fluid cooling medium remains in the same state. For example, in some embodiments, a fluid cooling medium may transition from a liquid to a vapor and back while traversing path 112.

The second cooling system may also include a heat pipe. In some embodiments, the heat pipe may include a wicking structure and a cooling medium that transitions through a phase change. In these embodiments, pump 104 is not included and path 112 represents the cooling path within the heat pipe. A heat pipe may be any shape. For example, in some embodiments, a heat pipe may be rectangular, and the rectangle may cover heat generating device 102 and heat exchanger 108. In other embodiments, a heat pipe may be other than rectangular. For example, a heat pipe may be a serpentine shape to traverse one or more heat generating devices as well as a remote heat exchanger.

In some embodiments, heat generating device 102 includes a heat sink through which the fluid cooling medium can pass. In other embodiments, heat generating device 102 includes packaging having integrated cooling passages through which the fluid cooling medium can pass. In still further embodiments, heat generating device 102 includes at least one surface in thermal contact with a heat pipe.

In some embodiments, electronic system 100 includes temperature sensors to sense a temperature of one or more components or subsystems of the system. For example, as shown in FIG. 1, electronic system 100 includes temperature sensor 130 to sense a temperature of fuel cell 110, and also includes temperature sensor 132 to sense a temperature of heat generating device 102. Any number of temperature sensors may be included in electronic system 100. Although only two temperature sensors are shown in FIG. 1, this is not a limitation of the present invention. Any type of temperature sensing device may be utilized. For example, in some embodiments, thermocouples or thermal diodes are used for temperature sensors. In some embodiments, temperature sensors may be used in conjunction with one or more control systems. Example embodiments of control systems are described below with reference to later figures.

Fuel cell 110, battery 120, and heat generating devices 102 and 140 are coupled by conductor 122. In some embodiments, fuel cell 110 provides power to heat generating devices 102 and 140, and to battery 120 using conductor 122. In this manner, fuel cell 110 may charge battery 120 and provide power to subsystems of electronic system 100.

In operation, an instantaneous power requirement of a subsystem or component may exceed the steady-state output of fuel cell 110. This may occur when a component requests more than the maximum output of fuel cell 110 or when a component experiences a transient power requirement above the current operating level of fuel cell 110. Battery 120 may provide power to subsystems during periods when power demands on fuel cell 110 are high. For example, battery 120 may provide power to heat generating device 102 or heat generating device 140 using conductor 122.

Fuel cell 110 may produce power (and heat) at various rates. For example, if fuel is delivered to fuel cell 110 at a low rate, the power and heat produced by fuel cell 110 may be relatively low. In contrast, if fuel is delivered to fuel cell 110 at a high rate, the power and heat produced by fuel cell 110 may be relatively high. The fuel delivery rate may be modified using various settings for fuel delivery pump 126.

In some embodiments, cooling system pump 104 includes a variable control. By varying the rate at which pump 104 pumps the fluid cooling medium, the amount of cooling provided by the second cooling system may be varied. Some embodiments of the present invention include intelligent control of the fuel delivery pump and the cooling system pump to allow for efficient power delivery and heat removal. Example embodiments are described with reference to later figures.

Electronic system 100 is shown with major components in a block diagram. Electronic system 100 may include many more subsystems, components, and the like, without departing from the scope of the present invention. Further, electronic system 100 may be any platform that may benefit from a fuel cell and integrated cooling system. For example, in some embodiments, electronic system 100 may be a notebook computer or a laptop computer, and may include many additional computer components.

In some embodiments, system 100 includes an antenna such as antenna 103 or antenna 143. Antenna 103 or antenna 143, or both, may be used to transmit and receive signals. For example, in some embodiments, heat generating device 102 may include wireless communications capabilities, and antenna 103 may be coupled to integrated circuits, components, or subsystems within heat generating device 102. Also for example, in some embodiments, heat generating device 140 may include wireless communications capabilities, and antenna 143 may be coupled to integrated circuits, components, or subsystems within heat generating device 140. Any of the disclosed embodiments may have wireless communications capabilities, and also may include one or more antennae.

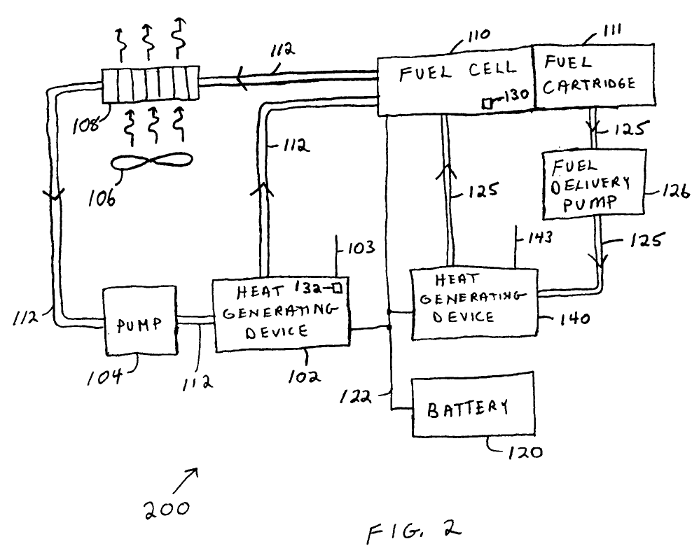

FIG. 2 shows an electronic system with two cooling systems. Electronic system 200 includes the same first cooling system as electronic system 100 (FIG. 1) used to cool heat generating device 104 and pre-heat fuel for fuel cell 110. Electronic system 200 also includes a second cooling system adapted to cool fuel cell 110 and heat generating device 102. Path 112 traverses heat generating device 102 and fuel cell 110 to remove heat from those devices, and also traverses heat exchanger 108 to remove heat from electronic system 200.

In some embodiments, the second cooling system is adapted to cool fuel cell 110 by pumping a fluid cooling medium either past or through a portion of the fuel cell. In other embodiments, the second cooling system may include a heat pipe. In some embodiments, the heat pipe may include a wicking structure and a cooling medium that transitions through a phase change. In these embodiments, pump 104 is not included and path 112 represents the cooling path within the heat pipe. A heat pipe may be any shape. For example, in some embodiments, a heat pipe may be rectangular, and the rectangle may cover heat generating device 102, fuel cell 110, and heat exchanger 108. In other embodiments, a heat pipe may be other than rectangular. For example, a heat pipe may be a serpentine shape to traverse one or more heat generating devices, fuel cell 110, as well as a remote heat exchanger.

As shown in FIG. 2, path 112 traverses in the order of heat generating device 102, fuel cell 110, heat exchanger 108, and pump 104, but this is not a limitation of the present invention. For example, path 112 may traverse fuel cell 110 prior to heat generating device 102, or after heat exchanger 108. Further, in some embodiments, multiple heat exchangers are included. For example, path 112 may traverse one or more heat exchangers after passing through each heat generating device.

Fuel cell 110 may include a heat sink through which the fluid cooling medium in path 112 can pass. In other embodiments, fuel cell 110 includes electrodes with integrated cooling passages through which the fluid cooling medium can pass. Example embodiments of fuel cells with integrated cooling passages are described with reference to later figures.

In some embodiments, electronic system 200 includes temperature sensors to sense a temperature of one or more components or subsystems of the system. For example, as shown in FIG. 2, electronic system 200 includes temperature sensor 130 to sense a temperature of fuel cell 110, and also includes temperature sensor 132 to sense a temperature of heat generating device 102. Any number of temperature sensors may be included in electronic system 200. Although only two temperature sensors are shown in FIG. 2, this is not a limitation of the present invention. Any type of temperature sensing device may be utilized. For example, in some embodiments, thermocouples or thermal diodes are used for temperature sensors. In some embodiments, temperature sensors may be used in conjunction with one or more control systems. Example embodiments of control systems are described below with reference to later figures.

Electronic system 200 is shown with major components in a block diagram. Electronic system 200 may include many more subsystems, components, and the like, without departing from the scope of the present invention. Further, electronic system 200 may be any platform that may benefit from a fuel cell and integrated cooling system. For example, in some embodiments, electronic system 200 may be a notebook computer or a laptop computer, and may include many additional computer components.

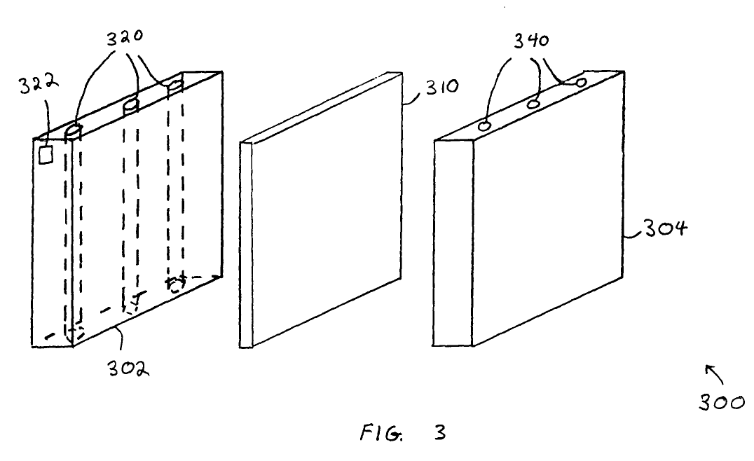

FIG. 3 shows an exploded view of a fuel cell. Fuel cell 300 includes electrodes 302 and 304, and stack 310. Fuel cell 300 may be any type of fuel cell that includes electrodes. For example, fuel cell 300 may be a direct methanol fuel cell, a reformed methanol fuel cell, or the like. Fuel cell 300 may be included in an electronic system with integrated platform and fuel cell cooling. For example, fuel cell 300 may be used as fuel cell 110 (FIGS. 1, 2). Stack 310 is shown thin for ease of illustration. In some embodiments, stack 310 includes membranes, electrolytes, and the like. Further, in some embodiments, stack 310 includes more electrodes to allow multiple cells to be electrically coupled in series.

As shown in FIG. 3, electrode 302 includes fluid passageways 320, and electrode 304 includes fluid passageways 340. Fluid passageways 320 and 340 may be utilized to carry a fluid cooling medium. In some embodiments, the passageways 320 and 340 are interconnected. For example, in some embodiments, a fluid path exists within electrode 302, between electrodes 302 and 304, and within electrode 304. In these embodiments, a fluid inlet may be present on electrode 302, and a fluid outlet may be present on electrode 304.

In some embodiments, a fluid passageway exists in a heatsink that is separate from electrode 302. In these embodiments, the heatsink may be part of a fluid cooling path, and the heatsink may be thermally affixed to one or both of electrodes 302 or 304. Further, in some embodiments, a heat pipe may be thermally coupled to a portion of fuel cell to remove heat. For example, a heat pipe may be in thermal contact with either or both of electrodes 302 and 304.

In some embodiments, fuel cell 300 includes one or more temperature sensors. As shown in FIG. 3, fuel cell 300 includes temperature sensor 322 coupled to electrode 302. A temperature sensor may be coupled to an electrode with a fluid passageway or to an electrode without a fluid passageway. A temperature sensor may also be coupled to a part of fuel cell 300 other than an electrode.

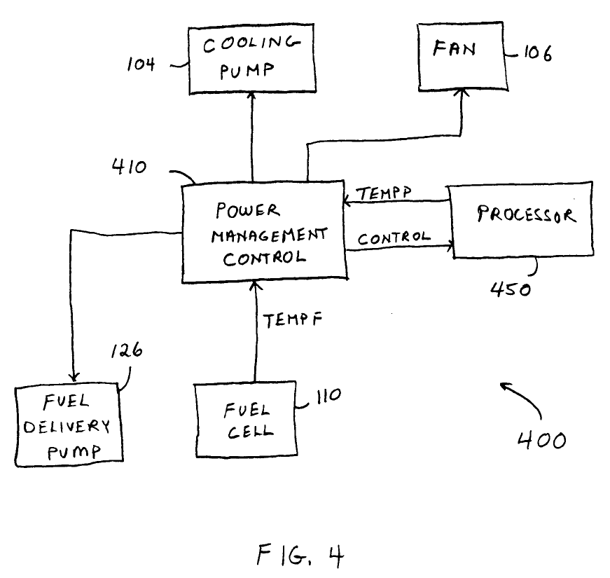

FIG. 4 shows a diagram of a control system. Control system 400 includes power management control block 410, fuel delivery pump 126, cooling pump 104, fan 106, fuel cell 110, and processor 450. In operation, power management control block 410 receives a fuel cell temperature (TEMPF) from a temperature sensor in fuel cell 110, and also receives a processor temperature (TEMPP) from a temperature sensor in processor 450. In some embodiments, the processor temperature corresponds to the junction temperature of transistors within processor 450. Power management control block 410 may also receive temperature information from other components. For example, power management control block 410 may receive temperature information describing the temperature of memory devices or controllers, graphics devices or controllers, or the like.

In response to temperature information, power management control block 410 may vary the rate of cooling pump 104, fan 106, and/or fuel delivery pump 126. Power management control block 410 may also control the frequency or performance of processor 450. For example, if one or more temperatures are high, then power management control block 410 may increase the flow rate of cooling pump 104, increase the speed of fan 106, reduce the voltage of processor 450, reduce the operating frequency of processor 450, reduce the rate of fuel delivery pump 126, or any combination. If one or more temperatures are low, power management control block 410 may decrease the flow rate of cooling pump 104, decrease the speed of fan 106, increase the voltage of processor 450, increase the operating frequency of processor 450, increase the flow rate of fuel delivery pump 126, or any combination.

Power management control block 410 may be implemented in any suitable manner. For example, in some embodiments, power management control block 410 may be implemented in hardware as a state machine or a dedicated sequential controller. Also for example, in other embodiments, power management control block 410 may be implemented in software as part of an operating system or power management software application. Power management control block 410 may also be implemented as a combination of hardware and software. The manner in which power management control block 410 is implemented is not a limitation of the present invention.

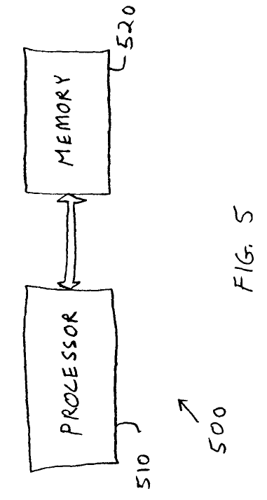

FIG. 5 shows an electronic system having a processor and memory. FIG. 5 shows system 500 including processor 510, and memory 520. Processor 510 may be a processor that can run an operating system that implements a control block such as that shown in FIG. 4. For example, processor 510 may receive temperature information and power information, and modify power output levels or power consumption levels, or modify cooling system performance. Also for example, processor 510 may perform any of the method embodiments of the present invention. Processor 510 represents any type of processor, including but not limited to, a microprocessor, a microcontroller, a digital signal processor, a personal computer, a workstation, or the like.

Memory 520 represents an article that includes a machine readable medium. For example, memory 520 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by processor 520. Memory 520 can store instructions for performing the execution of the various method embodiments of the present invention.

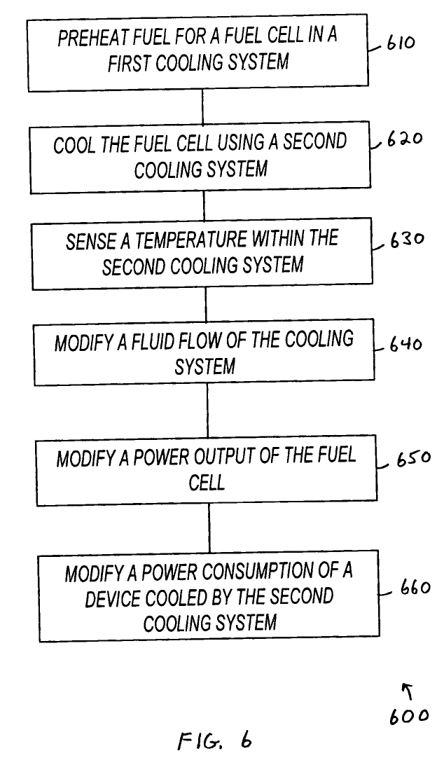

FIG. 6 shows a flowchart in accordance with various embodiments of the present invention. In some embodiments, method 600 may be used to modify power output or power consumption of various devices. In other embodiments, method 600 may be used to modify heat generation or cooling of various devices. In some embodiments, method 600, or portions thereof, is performed by a an electronic system with integrated platform and fuel cell cooling, or a control system, embodiments of which are shown in the various figures. Method 600 is not limited by the particular type of apparatus, software element, or person performing the method. The various actions in method 600 may be performed in the order presented, or may be performed in a different order. Further, in some embodiments, some actions listed in FIG. 6 are omitted from method 600.

Method 600 is shown beginning at block 610 in which fuel for a fuel cell is pre-heated in a first cooling system. For example, the fuel may flow in a fluid path that flows past a heat generating device. The heat generating device may be cooled, and the fuel may be pre-heated. Examples of systems in which fuel is preheated in a cooling system are shown in FIGS. 1 and 2. At 620, the fuel cell is cooled in a second cooling system.

At 630, a temperature is sensed within a cooling system adapted to cool a heat generating device. In some embodiments, the cooling system is also adapted to cool a fuel cell. In some embodiments, the heat generating device may be powered by the fuel cell, or partially powered by the fuel cell. The sensed temperature may be a temperature of the fuel cell or may be a temperature of the heat generating device. For example, the temperature of a processor such as processor 450 (FIG. 4) may be sensed, or the temperature of a fuel cell such as fuel cell 110 (FIGS. 1, 2) may be sensed.

At 640, a fluid flow of the cooling system is modified. The fluid flow may be modified by modifying a flow rate of a cooling system pump such as pump 104 (FIGS. 1, 4). In addition to modifying a fluid flow, a fan speed may also be modified. In some embodiments, the fluid flow or fan speed may be modified to increase the cooling effect of the cooling system in response to elevated temperatures. In other embodiments, the fluid flow or fan speed may be modified to decrease the cooling effect of the cooling system in response to reduced temperatures.

At 650, a power output of the fuel cell may be modified. The power output of the fuel cell may be modified by modifying a flow rate of a fuel delivery pump such as fuel delivery pump 126 (FIGS. 1, 2, 4). In some embodiments, the power output of the fuel cell may be increased due to increased power requirements. In other embodiments, the power output of a fuel cell may be increased to charge a battery when the cooling system has excess cooling capacity. For example, a control system such as control system 400 (FIG. 4) may sense lower temperatures that indicate the cooling system has extra cooling capacity. The extra cooling capacity may be utilized by increasing the flow of a fuel delivery pump to increase the power generation of the fuel cell to charge a battery.

At 660, the power consumption of the at least one device may be modified. In some embodiments, actions represented by block 650 may correspond to throttling the performance of a microprocessor to reduce the generated heat. For example, a control system may reduce the power consumption of a processor when a temperature of the processor is elevated. Likewise, in some embodiments, a control system may increase the power consumption of a processor to increase performance when the temperature of the processor is low.

Method 600 represents the intelligent control of power generation, power consumption, and cooling in an electronic system with integrated platform and fuel cell cooling. When excess cooling capacity exists in the cooling system, the excess cooling capacity may be used to produce more power with a fuel cell to charge a battery or to power the system to a higher performance level.

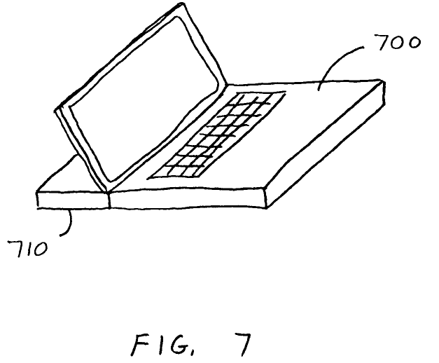

FIGS. 7-9 show electronic systems in accordance with various embodiments of the present invention. Each of FIGS. 7-9 may include systems such as electronic system 100 (FIG. 1), electronic system 200 (FIG. 2), or control system 400 (FIG. 4). Further, each of the electronic systems shown in FIGS. 7-9 may include wireless communications capabilities, and further may include one or more antennae.

FIG. 7 shows a computer having an external fuel cell. External fuel cell 710 may be a fuel cell such as fuel cell 110 (FIGS. 1, 2) or fuel cell 300 (FIG. 3). In some embodiments, external fuel cell 710 is coupled to computer 700 by multiple conductors and fluid lines. For example, conductors may be provided to receive power from fuel cell 710 and also to receive temperature information from a temperature sensor within fuel cell 710. Conductors may also be provided to allow computer 700 to modify the flow rate of a fuel delivery pump in fuel cell 700. In some embodiments, fluid lines with quick-disconnects may be included to between fuel cell 710 and computer 700 to allow the easy removal of fuel cell 710.

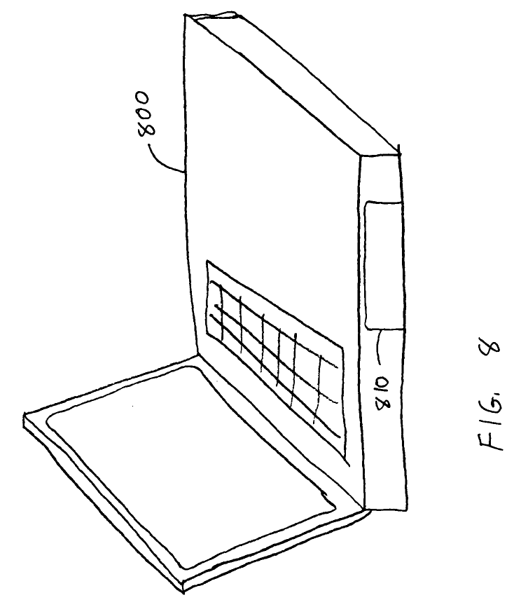

FIG. 8 shows a computer with a fuel cell in a “swappable bay.” As used herein, the term “swappable bay” refers to a bay substantially within the form factor of computer 800. The swappable bay may or may not accept devices other than fuel cell 810. For example, the swappable bay may accept devices such as a DVD drive, a battery, or the like.

Fuel cell 810 may be a fuel cell such as fuel cell 110 (FIGS. 1, 2) or fuel cell 300 (FIG. 3). In some embodiments, the swappable bay includes multiple electrical conductors and fluid lines. For example, conductors may be provided to receive power from fuel cell 810 and also to receive temperature information from a temperature sensor within fuel cell 810. Conductors may also be provided to allow computer 800 to modify the flow rate of a fuel delivery pump in fuel cell 800. In some embodiments, fluid lines with quick-disconnects may be included to between fuel cell 810 and computer 800 to allow the easy removal of fuel cell 810.

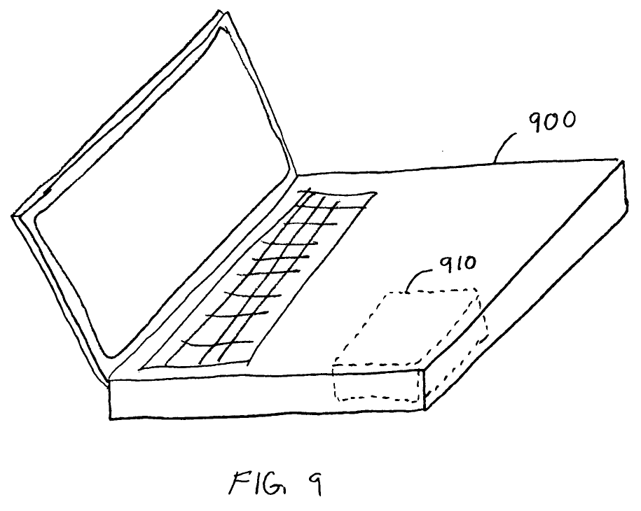

FIG. 9 shows a computer with a semi-permanently affixed fuel cell. As used herein, the term “semi-permanently affixed” refers to a device that is not designed to be readily removed by a consumer. Although fuel cell 910 is semi-permanently affixed within computer 900, a fuel cartridge within, or coupled to, fuel cell 910 may be readily removed by a consumer. For example, in embodiments that include a fuel cell powered by methanol, a disposable or refillable methanol canister may be readily removable. Fuel cell 910 may be a fuel cell such as fuel cell 110 (FIGS. 1, 2) or fuel cell 300 (FIG. 3).

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. An apparatus comprising:
a fuel cell to receive a fuel;
an integrated circuit; and
a cooling system to cool the integrated circuit, wherein the cooling system includes a fluid path for the fuel.

2. The apparatus of claim 1 further comprising:
a second integrated circuit; and
a second cooling system to cool the second integrated circuit wherein the second cooling system includes a fluid cooling medium.

3. The apparatus of claim 2 wherein the fuel cell includes at least one electrode through which the fluid cooling medium can pass.

4. The apparatus of claim 3 further comprising a pump to pump the fluid cooling medium.

5. The apparatus of claim 3 wherein the second cooling system comprises a heat pipe.

6. The apparatus of claim 2 wherein the second cooling system is adapted to cool the fuel cell.

7. The apparatus of claim 6 further comprising at least one temperature sensor.

8. The apparatus of claim 7 wherein the temperature sensor is configured to sense a temperature of the fuel cell.

9. The apparatus of claim 7 wherein the temperature sensor is configured to sense a temperature of the second integrated circuit.

10. The apparatus of claim 7 further comprising a control system adapted to modify a fluid flow in response to a temperature sensed by the temperature sensor.

11. The apparatus of claim 7 further comprising a control system adapted to modify a power output level of the fuel cell in response to a temperature sensed by the temperature sensor.

12. The apparatus of claim 2 wherein the integrated circuit comprises a processor.

13. The apparatus of claim 2 wherein the fluid cooling medium comprises a liquid metal.

14. The apparatus of claim 2 wherein the second cooling system is adapted to have the fluid medium pass through a phase change.

15. An apparatus comprising:
a fuel cell having an electrode with fluid passages through which a fluid cooling medium can pass; and
a heat generating device to preheat fuel for the fuel cell.

16. The apparatus of claim 15 further comprising a pump to pump the fluid cooling medium through the fluid passages.

17. The apparatus of claim 15 wherein the heat generating device comprises an integrated circuit.

18. The apparatus of claim 17 wherein the integrated circuit comprises a graphics circuit.

19. The apparatus of claim 17 wherein the integrated circuit comprises a processor.

20. The apparatus of claim 17 further comprising a cooling system coupled to the fluid passages.

21. The apparatus of claim 20 wherein the fluid cooling medium comprises a liquid metal.

22. The apparatus of claim 20 further comprising a second integrated circuit adapted to be cooled by the cooling system.

23. The apparatus of claim 20 further comprising a temperature sensor.

24. The apparatus of claim 23 further comprising a control system to increase the fuel cell output when a temperature sensed by the temperature sensor drops.

25. A method comprising:
preheating a fuel for a fuel cell in a first cooling system; and
cooling the fuel cell in a second cooling system.

26. The method of claim 25 further comprising:
sensing a temperature within the second cooling system; and
modifying a power output of the fuel cell.

27. The method of claim 26 wherein sensing a temperature comprises sensing a temperature of the fuel cell.

28. The method of claim 26 wherein sensing a temperature comprises sensing a temperature of a device cooled by the second cooling system.

29. An electronic system comprising:
a fuel cell to receive a fuel;
an integrated circuit;
a cooling system to cool the integrated circuit, wherein the cooling system includes a fluid path for the fuel; and
an antenna coupled to the integrated circuit.

30. The electronic system of claim 29 wherein the electronic system comprises a computer.

31. The electronic system of claim 30 wherein the fuel cell is external to the computer.

32. The electronic system of claim 30 wherein the fuel cell is in a swappable bay of the computer.

33. The electronic system of claim 30 wherein the fuel cell is semi-permanently affixed within the computer.
